(19) United States
(12) Patent Application Publication
(10) Pub. No.: US 2026/0135456 A1
(43) Pub. Date: May 14, 2026

(54) LINEAR VIBRATION GENERATING DEVICE

(71) Applicant: JAHWA ELECTRONICS CO., LTD., Cheongju-si (KR)

(72) Inventors: Kyung Hoon JO, Cheongju-si (KR); Seok Min KIM, Cheongju-si (KR); Young Bin CHONG, Cheongju-si (KR); Nam Jin CHOI, Cheongju-si (KR); Won Gook LEE, Cheongju-si (KR); Min Goo LEE, Cheongju-si (KR)

(73) Assignee: JAHWA ELECTRONICS CO., LTD., Cheongju-si (KR)

(21) Appl. No.: 19/350,190

(22) Filed: Oct. 6, 2025

(30) Foreign Application Priority Data
Nov. 13, 2024 (KR) 10-2024-0161008

(51) Int. Cl. H02K 33/18

(52) U.S. Cl. CPC H02K 33/18

(57) ABSTRACT

A horizontal linear vibration generating device. The horizontal linear vibration generating device includes: a case configured to form a mounting space therein by being coupled with a lower cover; a vibrating body configured to vibrate in a first direction within the mounting space; a fixing body including a coil surrounded by the vibrating body and a yoke around which the coil is wound; and a pair of elastic bodies configured to elastically support vibration of the vibrating body between the case and the vibrating body, in which the vibrating body may include: a frame portion to which the elastic bodies are connected; and a plurality of magnets mounted on an inner surface of the frame portion, the elastic bodies may include: a first elastic body configured to elastically support the vibration of the vibrating body from one side; and a second elastic body supports the vibration of the vibrating body.

### CROSS REFERENCE TO RELATED APPLICATION

The present application claims priority to Korean Patent Application No. 10-2024-0161008, filed on Nov. 13, 2024, the entire contents of which are hereby incorporated by reference in its entirety.

### FIELD

The present invention relates to a linear vibration generating device, and more particularly, to a horizontal linear vibration generating device in which a vibrating body generates vibration while oscillating in a horizontal direction by interaction between an electric field generated by a coil and a magnetic field generated by a magnet.

### BACKGROUND

In the related art, an eccentric rotary type vibration generating device has mainly been used as a vibration generating device that generates an incoming signal through vibration. However, the vibration generating device having an eccentric rotary structure does not guarantee a long lifespan, lacks fast responsiveness, and has a limitation in implementing various vibration modes. Accordingly, in the market where smartphones using a touch operation method are rapidly spreading, it is difficult to sufficiently satisfy the demands of consumers.

In this regard, a device called a linear vibrator or a linear vibration generating device, which generates vibration by linearly oscillating a mass body, has been developed. The linear vibration generating device basically uses a first-order vibration system. More specifically, it operates on a principle in which a mass body is oscillated in a horizontal direction to generate vibration using a force (Lorentz force) resulting from the interaction between an electric field generated by a coil and a magnetic field of a permanent magnet.

The linear vibration generating device is designed such that the electromagnetic force generated between the coil and the magnet and the physical elastic force provided by an elastic body have mutual resonance characteristics. When power having a frequency component of a time-variant characteristic is applied to the coil to generate an electromagnetic force, this generated electromagnetic force and the elastic force of the elastic body interact with each other, and the vibrating body reciprocates at a high speed in the horizontal direction, thereby generating vibration.

Although the linear vibration generating device may have slightly different specific vibration characteristics depending on a winding direction of the coil, a disposition of the yoke, a disposition of the magnet, and a coupling relationship of the elastic body, in any case, movement in directions other than the main vibration direction needs to be suppressed.

If movement in a direction other than a main vibration direction is excessively induced and the vibrating body deviates from a main vibration section, a problem may occur in which abnormal noise and vibration are generated by collision with other members such as a housing, or components are damaged.

In addition, in a conventional linear vibration generating device, a plate spring is adopted for the periodic reciprocating motion of the vibrating body, and the plate spring is joined to the vibrating body, and the plate spring to the housing, by welding, but there is a problem in that sufficient durability is difficult to secure because repeated stress is applied to the welded portions.

To solve such problems, Japanese Laid-Open Patent Publication No. 2019-062627 has proposed a method in which a connection surface bending portion is formed on the plate spring welded to the vibrating body, thereby dispersing and alleviating stress applied to the vibrating body and the plate spring.

However, such a connection surface bending portion may cause interference with the housing, and the movement of the plate spring may be constrained by the housing, which may ultimately cause the elastic force of the plate spring to vary, thereby resulting in a problem in which targeted vibration characteristics cannot be obtained.

Accordingly, a method of structurally reinforcing the portion to which the plate spring is joined has also been applied to increase stress resistance performance and enhance durability. In a specific configuration, a fixed reinforcement plate is attached to the joined portion where welding is performed, to enhance a coupling force.

Although this method of attaching the fixed reinforcement plate is the easiest way to enhance a coupling force, a problem may occur in which the fixed reinforcement plate is detached due to repeated loads.

Additionally, in most conventional linear vibration generating devices, due to the structural imperfection in implementing a magnetic closed circuit, there is an disadvantage in that a large amount of magnetic flux leakage occurs, causing degradation of vibration performance and a delay in response speed, and there is a problem in that variability in vibration performance is large even among products of the same specification depending on manufacturing deviation of the elastic body or fixing position of the elastic body during an assembly process.

### DOCUMENTS OF RELATED ART

Japanese Laid-Open Patent Publication No. 2019-062627 (published on Apr. 18, 2019)

### SUMMARY

A technical object to be solved by the present invention is to provide a horizontal linear vibration generating device capable of exhibiting improved vibration performance by securing a maximum stroke in a main vibration direction by suppressing abnormal motion in a vertical direction perpendicular to the main vibration direction of a vibrating body.

Another technical object to be solved by the present invention is to provide a linear vibration generating device capable of enhancing assemblability by concentrating magnetic flux in a given space to further increase the magnitude of generated electromagnetic force, while improving durability of a connection portion at which an elastic body and a vibrating body are connected to each other, and securing a welding point at a position convenient for operation.

To solve the objects, there is provided a horizontal linear vibration generating device, according to an embodiment of the present invention. The horizontal linear vibration generating device may include: a case configured to form a mounting space therein by being coupled with a lower cover; a vibrating body configured to vibrate in a first direction within the mounting space; a fixing body including a coil surrounded by the vibrating body and a yoke around which the coil is wound; and a pair of elastic bodies configured to elastically support vibration of the vibrating body between the case and the vibrating body, in which the vibrating body may include: a frame portion to which the elastic bodies are connected; and a plurality of magnets mounted on an inner surface of the frame portion, the elastic bodies may include: a first elastic body configured to elastically support the vibration of the vibrating body from one side; and a second elastic body configured to elastically support the vibration of the vibrating body from the other side facing the first elastic body, based on the fixing body, and the first elastic body and the second elastic body may include: a fixed end welded to the case; a movable end welded to the frame portion; and a connecting portion connecting the movable end and the fixed end to each other, in which positions on a plane of the fixed end and movable end of the first elastic body may be disposed to be diagonally symmetric to positions on a plane of the fixed end and movable end of the second elastic body, and a line connecting a movable welding point closest to a bridge portion among movable welding points of the movable end, to a fixed welding point closest to the bridge portion among fixed welding points of the fixed end, may be positioned within an angle of −5 degrees to +5 degrees with respect to a vertical line drawn in a second direction (y-axis direction) based on the movable welding point of the movable end.

Preferably, in an embodiment of the present invention, a line connecting the movable welding point closest to the bridge portion of the movable end, to a fixed welding point closest to a connecting portion of the fixed end, may coincide with a vertical line drawn in the second direction (y-axis direction) based on the movable welding point of the movable end.

Here, the pair of elastic bodies may be plate springs.

Further, the fixing body may have a shape symmetrical in the third direction perpendicular to a plane passing through the first direction and the second direction, and a longitudinal central axis of the yoke may coincide with a centerline passing through a center of a height of the vibrating body.

In addition, the frame portion, applied to an embodiment of the present invention, may include a first frame and a second frame, which are coupled in a structure in which portions thereof overlap each other on both sides of the fixing body, and a portion of the elastic body may be inserted and fixed into a gap in a portion where portions of the first frame and the second frame overlap each other.

In addition, each of the first frame and the second frame may include: a pair of a first binding portion and a second binding portion disposed in parallel in the first direction with the fixing body interposed therebetween; and a connecting portion connecting ends of the binding portions to each other, in which the first binding portion of the first frame and the second binding portion of the second frame may overlap each other in parallel in the first direction, and the second binding portion of the first frame and the first binding portion of the second frame may overlap each other in parallel in the first direction, and the first frame and the second frame are thus coupled.

Meanwhile, each of the first frame and the second frame may include: a front end protrusion formed to extend in the first direction from the first binding portion; and an engagement groove formed in a third direction in the connecting portion, and the first frame and the second frame may be coupled in such a manner that the front end protrusion of the first frame is fitted into the engagement groove of the second frame, and the front end protrusion of the second frame is fitted into the engagement groove of the first frame.

In addition, each of the first frame and the second frame may include: an upper groove for joining formed in an upper portion of the first binding portion; and a lower groove for joining formed in a lower portion of the first binding portion, in which the first elastic body and the second elastic body may be formed to have a height such that upper surfaces and lower surfaces of the first elastic body and the second elastic body are positioned on horizontal planes of the upper groove for joining and the lower groove for joining, such that movable welding points of the first elastic body may be spot-welded on horizontal planes of the upper groove for joining and the lower groove for joining of the first binding portion of the first frame, and movable welding points of the second elastic body may be spot-welded on horizontal planes of the upper groove for joining and the lower groove for joining of the first binding portion of the second frame.

Further, the plurality of magnets may include: first magnets, each mounted on a recessed surface portion formed in the first frame in correspondence to a front surface portion of the fixing body, and a recessed surface portion formed in the second frame in correspondence to a rear surface portion of the fixing body; and second magnets, each mounted on a surface of a binding frame directly facing one side surface portion of the fixing body among the binding frames of the first frame, and a surface of a binding frame directly facing the other side surface portion of the fixing body among the binding frames of the second frame.

According to an embodiment of the present invention, abnormal motion in the direction perpendicular to the main vibration direction on the plane of the vibration generating device is suppressed, and the stroke distance in the main vibration direction may be increased, so that the effect of improving vibration performance is exhibited.

In addition, since the magnetic substance frame included in the vibrating body has a structure of completely surrounding the fixing body, a magnetic closed circuit is formed in the planar direction, and as a result, the force (drive force) due to the interaction between the magnet and the coil is increased, so that the attraction, repulsion, and propulsion force of the vibrating body with respect to the fixing body are improved, thereby the overall vibration performance including power and response speed (responsiveness) is improved, and the vibration stability may be enhanced.

Further, due to the unique connection structure (a sandwiched-type connection structure) in which a portion of the elastic body is inserted and fixed in the overlapping portion of the magnetic substance frame, durability problems such as fracture of the elastic body, which frequently occurred at the connection portion where the elastic body and the vibrating body are connected to each other, may also be clearly and definitely resolved, and welding points are secured in positions convenient for operation, so that assemblability may be improved.

### BRIEF DESCRIPTION OF THE DRAWINGS

FIG. 1 is an assembled perspective view of a horizontal linear vibration generating device according to an embodiment of the present invention.

FIG. 2 is an exploded perspective view of a horizontal linear vibration generating device according to an embodiment of the present invention.

FIG. 3 is a cross-sectional view of the horizontal linear vibration generating device in FIG. 1, viewed in the direction of line A-A.

FIG. 4 is a cross-sectional view of the horizontal linear vibration generating device in FIG. 1, viewed in the direction of line B-B.

FIG. 5 is an enlarged view of a portion C and a portion D in FIG. 4.

FIG. 6 is an exploded perspective view of the horizontal linear vibration generating device according to an embodiment of the present invention, viewed in a flipped manner.

FIG. 7 is a perspective view of the horizontal linear vibration generating device according to an embodiment of the present invention, viewed in a state where a lower cover is removed.

FIG. 8 is a plan view of the horizontal linear vibration generating device according to an embodiment of the present invention, viewed in a state where the lower cover is removed.

FIG. 9 is a simulation result plan view illustrating maximum displacement states of the left and right sides when a welding point angle is a −θ angle in the horizontal linear vibration generating device according to an embodiment of the present invention.

FIG. 10 is a simulation result plan view illustrating maximum displacement states of the left and right sides when a welding point angle is θ degrees in the horizontal linear vibration generating device according to an embodiment of the present invention.

FIG. 11 is a simulation result plan view illustrating maximum displacement states of the left and right sides when a welding point angle is a +θ angle in the horizontal linear vibration generating device according to an embodiment of the present invention.

FIG. 12 is a graph illustrating a maximum displacement value in a second direction according to the welding point angle in the horizontal linear vibration generating device according to an embodiment of the present invention.

FIG. 13 is a conceptual view illustrating a rotation center, point of action, and motion direction of a plate spring according to a welding point angle in the horizontal linear vibration generating device according to an embodiment of the present invention.

### DETAILED DESCRIPTION OF THE EMBODIMENTS

Hereinafter, exemplary embodiments of the present invention will be described in detail. Prior to this, it is clarified that terms or words used in the present specification and the claims shall not be construed as being limited only to dictionary definitions, and based on the principle that an inventor may appropriately define the concept of a term to best describe his or her own invention, they shall be construed in the meaning and concept conforming to the technical teachings of the present invention.

Accordingly, it should be understood that the embodiment described in the present specification and the configuration illustrated in the drawings are merely one most preferred embodiment, and are not intended to represent all of the technical teachings of the present invention, and that, at the time of filing the present application, various equivalents and modified examples capable of substituting the embodiments may be made.

The embodiments of the present invention to be described hereinafter are applied to a hand-held terminal that receives signal feedback by vibration, where the hand-held terminal refers to a portable user device. However, this is merely a general term, and the horizontal linear vibration generating device of the present invention is applicable to a variety of devices or fields such as a mobile phone, a palm sized personal computer (PC), a personal communication system (PCS), a personal digital assistant (PDA), a hand-held PC (HPC), a smart phone, a wireless local area network (LAN) terminal, a laptop computer, a netbook, a tablet personal computer, a non-mobile gaming device, a virtual reality (VR) device, and a vehicle.

Before describing the present invention, the terms related to directions are defined first:
a first direction (x-axis direction in the drawings) refers to a main vibration direction in which a vibrating body vibrates with respect to a fixing body in the drawings; and a second direction (y-axis direction in the drawings) refers to a direction orthogonal to the first direction on the plane of the horizontal linear vibration generating device of the present invention. Further, a third direction (z-axis direction in the drawings) refers to a direction perpendicular to the plane on which the first direction and the second direction lie.

Hereinafter, with reference to the drawings, a preferred embodiment of the present invention will be described in detail.

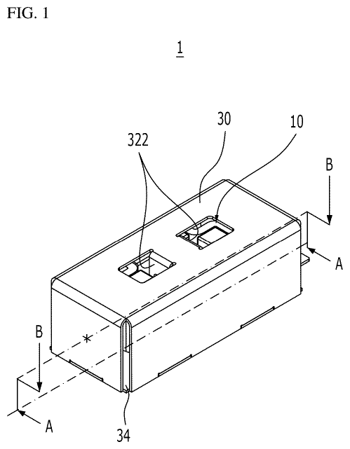

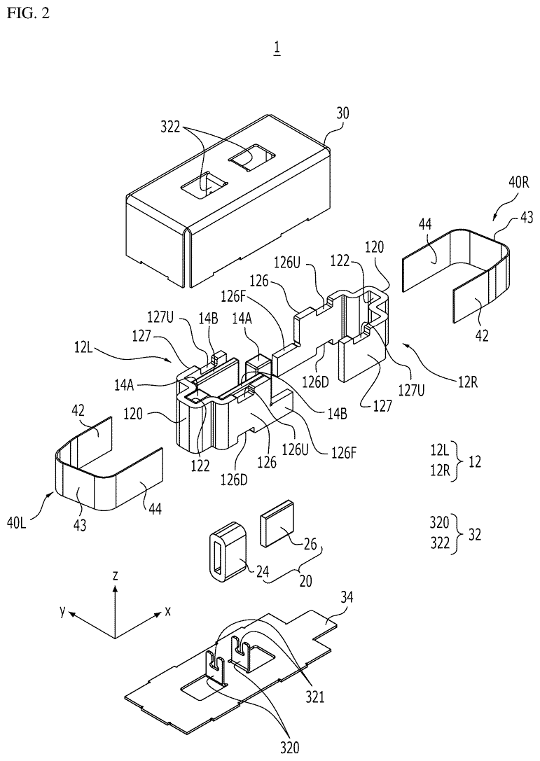

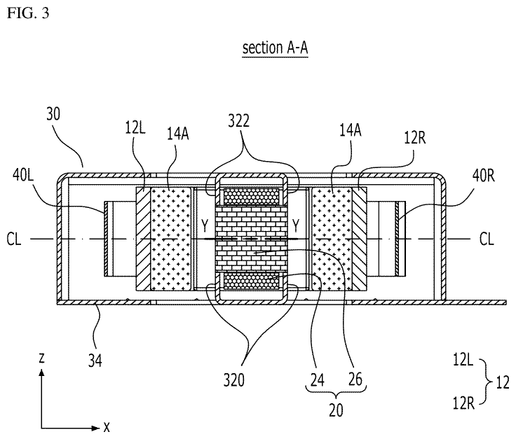

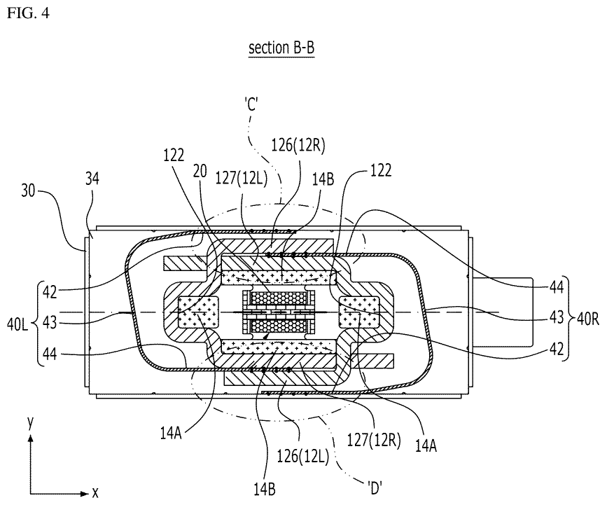

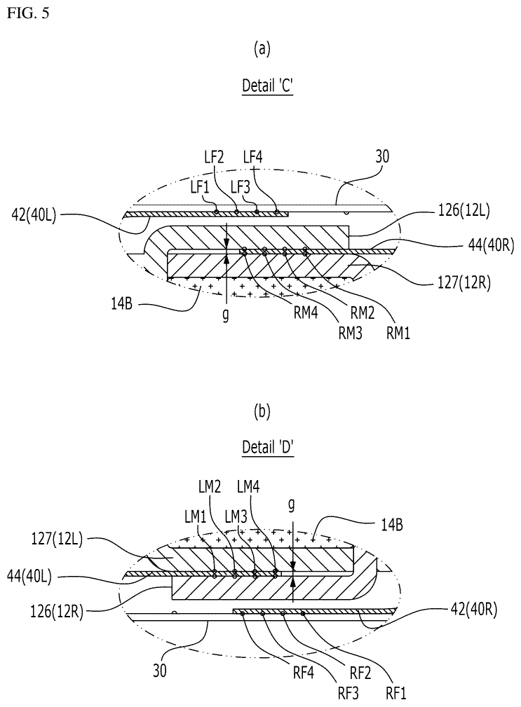

FIG. 1 is an assembled perspective view of a horizontal linear vibration generating device according to an embodiment of the present invention, and FIG. 2 is an exploded perspective view of a horizontal linear vibration generating device according to an embodiment of the present invention. FIG. 3 is a cross-sectional view of the horizontal linear vibration generating device in FIG. 1, viewed in the direction of line A-A, FIG. 4 is a cross-sectional view of the horizontal linear vibration generating device in FIG. 1, viewed in the direction of line B-B, and FIG. 5 is an enlarged view of a portion C and a portion D in FIG. 4.

With reference to FIGS. 1 to 5, a horizontal linear vibration generating device 1 according to an embodiment of the present invention includes a case 30 that forms a mounting space therein by being coupled to a lower cover 34, a vibrating body 10 that vibrates in a first direction within the mounting space, a fixing body 20 including a coil 24 surrounded by the vibrating body and a yoke 26 around which the coil is wound, and a pair of elastic bodies 40 that elastically support vibration of the vibrating body between the case 30 and the vibrating body 10, in which the vibrating body includes a frame portion 12 to which the elastic bodies are connected, and a plurality of magnets 14A and 14B mounted to an inner surface of the frame portion.

The elastic body 40 includes a first elastic body 40L that elastically supports vibration of the vibrating body from one side, and a second elastic body 40R that elastically supports vibration from the other side facing the first elastic body, based on the fixing body. The first elastic body and the second elastic body include a fixed end 42 welded to the case, a movable end 44 welded to the frame portion, and a bridge portion 43 connecting the movable end and the fixed end. Positions on a plane of the fixed end 42 and the movable end 44 of the first elastic body 40L are disposed diagonally symmetrical to positions on a plane of the fixed end 42 and the movable end 44 of the second elastic body 40R.

That is, the horizontal linear vibration generating device 1 of the present invention may be configured to include the vibrating body 10 and the fixing body 20. Here, the vibrating body 10 and the fixing body 20 are relative concepts to each other, where the fixing body 20 refers to a portion that is fixed with respect to the vibrating body 10, and the vibrating body 10 refers to a portion that vibrates with respect to the fixing body 20.

The vibrating body 10 is installed inside the case 30 that forms an exterior appearance of the device, and may perform linear motion (vibration) in which a motion direction changes with respect to the first direction through interaction with the fixing body 20, and the pair of elastic bodies 40L and 40R elastically support, from both sides, the linear motion in the first direction, that is, the vibration, of the vibrating body 10, whose motion direction changes between the vibrating body 10 and the case 30.

The case 30, as illustrated in the drawings, on a plane, may have a rectangular shape in which a length in the first direction is longer than a width in the second direction, and may be a cuboid structure having a lower portion open, and the lower cover 34 may be coupled to an open portion at a lower portion of the case 30.

The vibrating body 10, fixing body 20, and elastic bodies 40L and 40R may be mounted in a mounting space (an internal space partitioned by the case and the lower cover) formed by the coupling of the case 30 and the lower cover 34.

The fixing body 20 includes the coil 24 and the yoke 26. The coil 24 is electrically connected to a board (not illustrated) mounted on the lower cover 34, and structurally may be configured to be surrounded by the vibrating body 10 in the mounting space. Further, the yoke 26 may be positioned at the center of the mounting space while being lifted from the lower cover 34 by a support portion 32, in a state of being surrounded by the coil 24.

The support portion 32 that supports the fixing body 20 may include a pair of lower support structures 320 provided on the lower cover 34 and disposed with a distance in the first direction, and a pair of upper support structures 322 provided on the case 30 to correspond to the pair of lower support structures 320. In this case, the lower support structures 320 and the upper support structures 322 may be formed by cutting portions of the lower cover 34 and the case 30, and then bending the cut portions toward the mounting space.

At an upper end of the lower support structure 320 and a lower end of the upper support structure 322 facing the upper end of the lower support structure 320, a groove 321 in which the yoke 26 is seated and coupled is formed, so that the yoke 26 may be stably and firmly fixed at a predetermined position (approximately the center) of the mounting space, and as a result, separation or detachment of the yoke may be reliably prevented even under strong external impact such as drop impact.

The vibrating body 10 may be disposed to perform reciprocating motion, i.e., vibration, in the first direction in the mounting space formed by the coupling of the case 30 and the lower cover 34, and the pair of elastic bodies 40L and 40R may undergo elastic deformation according to the vibration of the vibrating body 10 in the first direction between the vibrating body 10 and the case 30, so that an amplitude of the vibrating body 10 may be limited to a predetermined amplitude.

The vibrating body 10 may include the frame portion 12 that surrounds the fixing body 20 and is connected to the elastic bodies 40L and 40R. In addition, the vibrating body 10 includes a plurality of magnets 14A and 14B mounted to an inner surface of the frame portion 12 facing the fixing body 20.

Further, preferably, the pair of elastic bodies is a plate spring.

In addition, the fixing body has a shape symmetrical in the third direction perpendicular to a plane passing through the first direction and the second direction, and more preferably, a longitudinal central axis of the yoke coincides with a centerline passing through a center of a height of the vibrating body.

That is, as illustrated in FIG. 3, the fixing body 20 has a shape symmetrical in the third direction (z-axis direction), and it is preferable that a longitudinal central axis Y-Y of the yoke 26 constituting the fixing body coincides with a centerline CL passing through the center of the height of the vibrating body. Through such configuration, displacement of the vibrating body in the third direction may be suppressed during driving of the vibrating body.

A main feature of the present invention lies in a positional relationship between a fixed welding point, which is a welding position at a fixed end of the elastic body welded to the case, and a movable welding point, which is a welding position at a movable end of the elastic body welded to the frame portion constituting the vibrating body, and a detailed structure of the frame portion may be variously implemented.

As an embodiment of the present invention, the frame portion 12 may be configured of a first frame 12L and a second frame 12R, which are coupled in a structure where portions thereof overlap each other. Further, a portion of the elastic body may be inserted and fixed into a gap in a portion where portions of the first frame 12L and the second frame 12R overlap each other.

In addition, with respect to the second direction, on both sides of the fixing body 20, the first frame 12L and the second frame 12R may be coupled in a structure in which respective portions constituting them overlap each other. Further, on both sides of the fixing body 20 in the second direction, a portion where portions of the first frame 12L and the second frame 12R are coupled in a structure of overlapping each other may have a portion of the elastic bodies 40L and 40R inserted and fixed.

In an embodiment of the present invention, the frame portion 12 composed of the lower cover 34, the case 30, and the first frame 12L and the second frame 12R may be a magnetic substance. Here, the term “magnetic substance” may refer to a metal having magnetism.

Further, the first frame 12L and the second frame 12R may be disposed diagonally symmetrical to each other, and may be disposed such that portions thereof overlap each other in the second direction. With reference to FIGS. 2 and 4, each of the first frame 12L and the second frame 12R may be configured to include a pair of first binding portion 126 and second binding portion 127 disposed in parallel with respect to the first direction, and a connecting portion 120 connecting ends of the binding portions 126 and 127 to each other.

Meanwhile, a recessed surface portion 122 may be formed in the connecting portion 120 of the first frame 12L and the connecting portion 120 of the second frame 12R. And, as illustrated in FIG. 4, the first binding portion 126 of the first frame 12L and the second binding portion 127 of the second frame 12R, which are positioned in the same direction based on the fixing body 20, overlap each other in parallel in the first direction, and the second binding portion 127 of the first frame 12L and the first binding portion 126 of the second frame 12R overlap each other in parallel in the first direction, and the first frame 12L and second frame 12R are thus coupled. In the overlapping portion, a predetermined gap (g) is formed such that a portion of the elastic body is inserted and fixed in the gap (g).

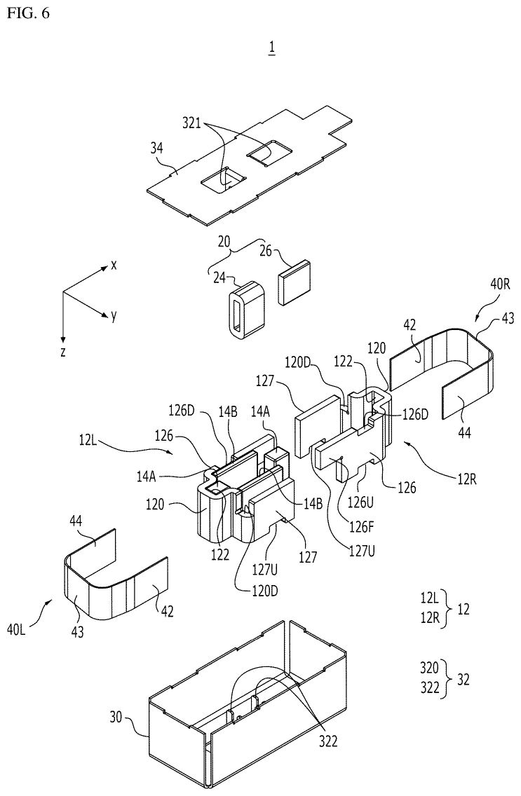

In addition, with reference to an exploded perspective view of FIG. 6, in which the horizontal linear vibration generating device of the present invention is viewed in a flipped manner, each of the first frame 12L and the second frame 12R includes a front end protrusion 126F formed to extend in the first direction from the first binding portion 126, and an engagement groove 120D formed in the third direction in the connecting portion 120, and are coupled in such a manner that the front end protrusion 126F of the first frame 12L is fitted into the engagement groove of the second frame 12R, and the front end protrusion 126F of the second frame 12R is fitted into the engagement groove 120D of the first frame 12L.

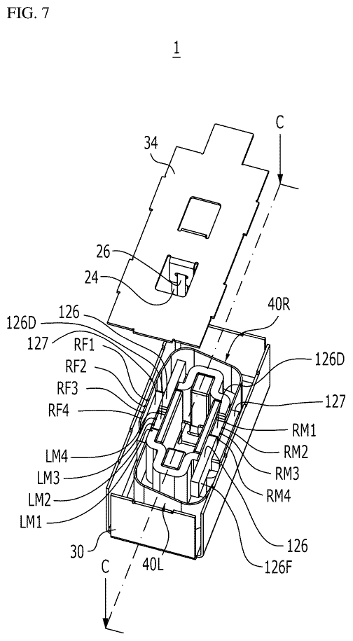

In addition, with reference to a perspective view of FIG. 7, in which the horizontal linear vibration generating device of the present invention is viewed in a flipped manner with the lower cover removed, and to FIG. 6, each of the first frame 12L and the second frame 12R may have an upper groove for joining 126U formed at an upper portion of the first binding portion 126, and a lower groove for joining 126D formed in a lower portion of the first binding portion 126, and the first elastic body 40L and the second elastic body 40R are formed to have a height such that upper surfaces and lower surfaces of the first elastic body 40L and the second elastic body 40R are positioned on horizontal planes of the upper groove for joining 126U and the lower groove for joining 126D, such that movable welding points LM1, LM2, LM3, and LM4 of the first elastic body 40L are spot-welded on the horizontal planes of the upper groove for joining 126U and the lower groove for joining 126D of the first binding portion 126 of the first frame 12L, and movable welding points RM1, RM2, RM3, and RM4 of the second elastic body are spot-welded on the horizontal planes of the upper groove for joining 126U and the lower groove for joining 126D of the first binding portion 126 of the second frame 12R.

In addition, the second binding portion 127 overlapping the first binding portion 126 preferably has a lower surface thereof placed on the same plane as the horizontal plane of the lower groove for joining 126D of the first binding portion 126, and the movable welding points of the first elastic body 40L and the second elastic body 40R may be spot-welded.

In addition, the upper groove for joining 127U may also be formed at an upper portion of the second binding portion 127, such that a horizontal plane of the upper groove for joining 127U, a horizontal plane of the upper groove for joining 126U formed on the upper portion of the first binding portion 126, and the upper surfaces of the first elastic body 40L and the second elastic body 40R may all be placed on the same plane, and at this portion, the movable welding points LM1, LM2, LM3, LM4, RM1, RM2, RM3, and RM4 may be spot-welded.

As such, the vibrating body 10 of the present invention is assembled to the case in a state in which the movable ends 44 of the elastic bodies are welded to the frame portion 12 and integrated. Then, the fixed ends 42 of the elastic bodies are welded to the case 30, and subsequently, the lower cover 34, to which the fixing body 20 is electrically coupled, is coupled, so that the fixing body 20 may be positioned inside the vibrating body 10.

Meanwhile, with reference to FIGS. 2 and 4, the plurality of magnets 14A, 14B constituting the vibrating body 10 may be configured to include two first magnets 14A and two second magnets 14B. The two first magnets 14A may be disposed in a structure facing each other in the first direction with the fixing body 20 interposed therebetween, and the two second magnets 14B may be disposed in a structure facing each other in the second direction with the fixing body 20 interposed therebetween.

The two first magnets 14A may be respectively mounted to the recessed surface portion 122 formed on the connecting portion 120 of the first frame 12L in correspondence to a front surface portion of the fixing body 20 (left end of the fixing body in FIG. 4), and to the recessed surface portion 122 formed on the connecting portion 120 of the second frame 12R in correspondence to a rear surface portion of the fixing body 20 (right end of the fixing body in FIG. 4).

Further, the two second magnets 14B may be respectively mounted on an inner surface of the first binding portion 126, among the pair of binding portions 126 constituting the first frame 12L, which directly faces one side surface portion of the fixing body 20 in the second direction, and on an inner surface of the second binding portion 127, among the pair of binding portions constituting the second frame 12R, which directly faces the other side surface portion of the fixing body 20 in the second direction.

As such, since the first magnets 14A and the connecting portions 120 are disposed in a structure surrounding both sides of the fixing body 20 in the first direction, a circulating magnetic loop in which magnetic field lines continuously circulate in a specific direction upon application of power may be formed, and since the binding portions 126 and 127, which overlap each other, are also configured in a form surrounding both sides of the fixing body 20 in the second direction, magnetic leakage to the outside in the second direction may be more reliably suppressed or blocked.

An electric current is applied to the coil 24 of the fixing body 20 through a board (not illustrated), and the coil 24 is magnetized by the applied electric current. Then, through the interaction between the magnetized coil 24 and the second magnets 14B, a force (Lorentz force) is generated. Further, due to the generated force, the vibrating body 10 vibrates in the first direction in accordance with a frequency response characteristic determined by its mass and an elastic coefficient of the elastic bodies 40L and 40R.

The elastic bodies 40L and 40R may be configured as the first elastic body 40L and the second elastic body 40R, and these elastic bodies are plate springs. The first elastic body 40L elastically supports vibration of the vibrating body 10 in the first direction from one side, and the second elastic body 40R elastically supports vibration of the vibrating body 10 in the first direction from the other side. Preferably, the first elastic body 40L and the second elastic body 40R may include the fixed end 42 coupled to the case 30, and the movable end 44 coupled in a form in which a portion thereof is inserted into the gap (g).

As illustrated in FIG. 4, positions on a plane of the fixed end 42 and the movable end 44 of the first elastic body 40L are diagonally symmetrical to positions on a plane of the fixed end 42 and the movable end 44 of the second elastic body 40R, and the movable end 44 and the fixed end 42 of the first elastic body 40L, and the movable end 44 and the fixed end 42 of the second elastic body 40R may be connected to each other via respective bridge portions 43 formed therein. Further, the movable end 44 and the bridge portion 43, and the bridge portion 43 and the fixed end 42 may be connected to each other through a curved portion having a predetermined curvature.

In this case, it is preferable that the bridge portion 43 is formed in a diagonal structure such that it becomes increasingly distant from the vibrating body 10 as it goes from the movable end 44 to the fixed end 42.

The first elastic body 40L and the second elastic body 40R may be coupled in a structure in which each movable end 44 is inserted into the gap (g) formed in a portion where portions of the first frame 12L and the second frame 12R overlap each other in parallel in the first direction, as illustrated in FIG. 4 and FIG. 5, which illustrates an enlarged view of a main portion of FIG. 4.

Further, in a state where the first binding portion 126 and the second binding portion 127 overlap each other in a sandwich structure with each movable end 44 interposed therebetween, the first binding portion 126, the respective movable ends 44 of the elastic body, and the second binding portion 127 are firmly coupled to each other by spot welding. In this case, as illustrated in FIG. 5, the spot welding is performed at four positions in the first direction, and movable welding points LM1, LM2, LM3, LM4, RM1, RM2, RM3, and RM4 may be formed, and more preferably, as described above, spot welding may be performed on upper and lower portions of the first binding portion 126 and the second binding portion 127.

In addition, each fixed end 44 of the first elastic body 40L and the second elastic body 40R may be spot-welded to an inner surface of the case, and thereby firmly coupled, and as illustrated in FIG. 5, the spot welding is performed at four respective positions in the first direction, and fixed welding points LF1, LF2, LF3, LF4, RF1, RF2, RF3, and RF4 may be formed.

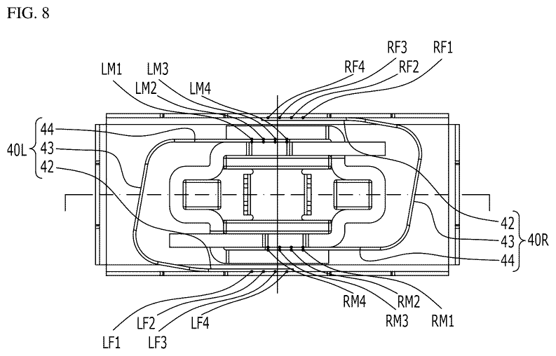

The movable welding points LM1 to LM4, RM1 to RM4 illustrated in FIGS. 4 and 5 are illustrated for reference, and actual welding positions are not the sectional views shown in FIG. 4, but the corresponding positions on a horizontal plane of the lower groove for joining 126D formed on a lower surface of the first binding portion 126 and a lower surface of the second binding portion 127 of each of the first frame 12L and the second frame 12R, as illustrated in FIGS. 7 and 8, which illustrate the horizontal linear vibration generating device of the present invention in a flipped manner. Similarly, the welding is performed on the corresponding positions on a horizontal plane of the upper groove for joining 126U formed on an upper surface of the first binding portion 126 and a horizontal plane of the upper groove for joining 127U formed on an upper surface of the second binding portion 127 of each of the first frame 12L and the second frame 12R illustrated in FIG. 2, so that movable welding points LM1 to LM4, RM1 to RM4 are formed.

In the illustrated example of the drawings, each of the movable welding points and the fixed welding points is illustrated to be formed at four positions. However, it is obvious that the number of these welding points is not limited to four and may be different from each other.

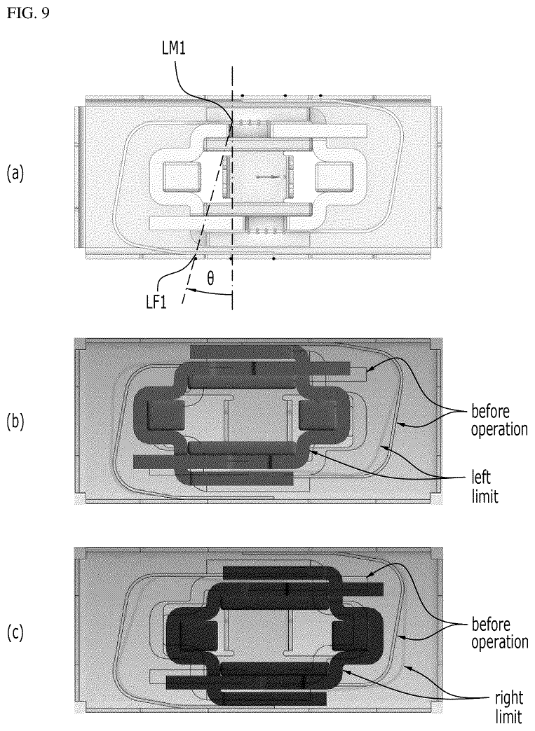

Next, the plan views of FIGS. 9, 10, and 11 are the results of simulating maximum displacement states on left and right sides when a welding point angle is −θ, θ, and +θ, respectively, in the horizontal linear vibration generating device according to an embodiment of the present invention.

LM1 shown in FIGS. 9 to 11 is a movable welding point closest to the bridge portion 43 among four movable welding points LM1 to LM4 of the movable end 44 of the first elastic body 40L illustrated in FIG. 8, and LF1 is a fixed welding point closest to the bridge portion 43 among four fixed welding points LF1 to LF4 of the fixed end 42 of the first elastic body 40L.

Further, FIG. 9 illustrates a simulation result in a case where a line connecting the movable welding point LM1, which is closest to the bridge portion, among the movable welding points of the movable end, to the fixed welding point LF1, which is closest to the bridge portion, among the fixed welding points of the fixed end, forms an angle of −θ with respect to a vertical line drawn in the second direction (y-axis direction) based on the movable welding point of the movable end (an angle of—refers to a clockwise rotation centered on the LM point), and this is an analysis result when the angle is −9 degrees.

As can be known through FIG. 9, in this case, the vibrating body undergoes a displacement occurrence in the second direction to such an extent that one end in the vertical direction of the vibrating body comes into contact with the side wall of the case in the 12 o'clock direction in the left maximum stroke state. Likewise, in the right maximum stroke state, displacement occurs to such an extent that the other end in the vertical direction of the vibrating body comes into contact with the side wall of the case in the 6 o'clock direction.

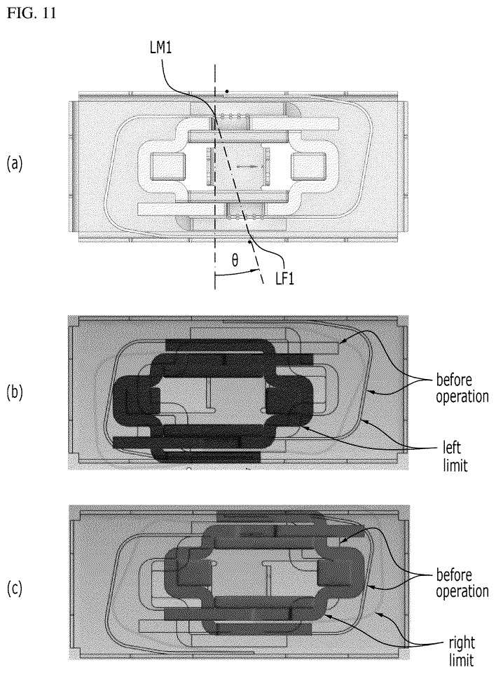

Further, FIG. 11 is an analysis result in case of +9 degrees. In this case, it can be seen that the vibrating body undergoes a displacement occurrence in the second direction to such an extent that one end in the vertical direction of the vibrating body comes into contact with the side wall of the case in the 6 o'clock direction in the left maximum stroke state, and displacement in the second direction occurs to such an extent that the other end in the vertical direction of the vibrating body comes into contact with the side wall of the case in the 12 o'clock direction in the right maximum stroke state.

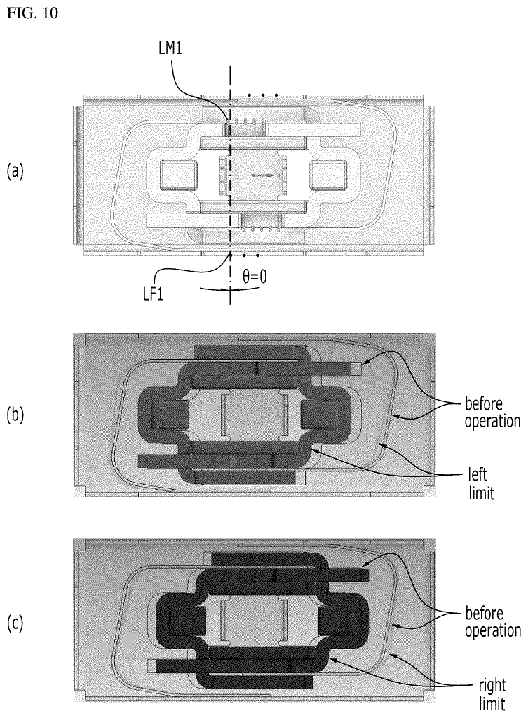

In contrast, FIG. 10 is an analysis result in case of θ=0 degrees. In this case, it indicates that the vibrating body does not come into contact at all with the side wall of the case in the 12 o'clock or 6 o'clock direction in either the left maximum stroke state or the right maximum stroke state.

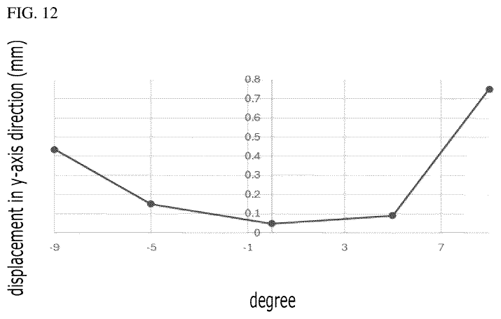

Next, FIG. 12 is a graph illustrating a maximum displacement value in the second direction according to a welding point angle in the horizontal linear vibration generating device according to an embodiment of the present invention, and it can be seen that the horizontal linear vibration generating device of the present invention exhibits a small displacement in the second direction when the angle θ is between −5 degrees and +5 degrees.

Accordingly, in the horizontal linear vibration generating device of the present invention, it is preferable that a line connecting, among movable welding points of the movable end, a movable welding point closest to the bridge portion to, from among fixed welding points of the fixed end, a fixed welding point closest to the bridge portion is positioned within an angle of −5 degrees to +5 degrees with respect to a vertical line drawn in the second direction (y-axis direction) based on the movable welding point of the movable end.

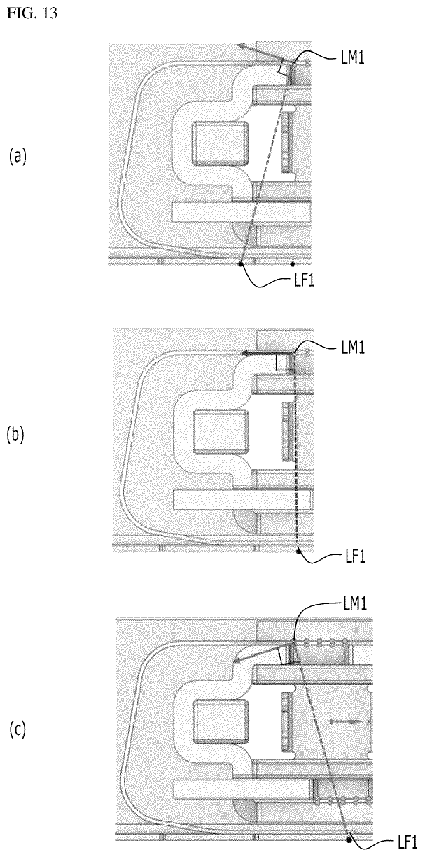

A difference in the behavior of the vibrating body according to the relationship between the movable welding point and the fixed welding point in the present invention may be understood through the conceptual diagram illustrating the rotation center, the point of action, and the motion direction of the elastic body according to the welding point angle in FIG. 13. Here, the fixed welding point LF1 becomes the rotation center, and the movable welding point LM1 becomes the point of action, and it can be seen that the motion direction of the point of action is determined in a direction perpendicular to the line connecting these two points.

That is, the rotation center and the point of action are determined according to the relative welding positions of the movable end and the fixed end of the elastic body that elastically supports the vibrating body between the vibrating body and the case, and it can be seen that, when a vibration generating force in the first direction (x-axis direction) acts, a difference in the motion direction occurs due to the moment of force. In this case, it can be seen that undesired displacement in the second direction is suppressed when the fixed welding point and the movable welding point are placed on the same line or close to this line in the first direction.

Further, when, as described above, the displacement in the second direction is suppressed, the occurrence of mechanical interference or touch noise with the vibrating body and the case, etc., is reduced. Accordingly, it becomes unnecessary to devise additional means such as a damper in order to reduce such interference or noise.

### DESCRIPTION OF REFERENCE NUMERALS

1: Horizontal linear vibration generating device
10: Vibrating body
12: Frame portion
12L: First frame
12R: Second frame
14A: First magnet
14B: Second magnet
20: Fixing body
24: Coil
26: Yoke
30: Case
32: Support portion
34: Lower cover
40L: First elastic body
40R: Second elastic body
42: Fixed end
43: Bridge portion
44: Movable end
120: Connecting portion
120D: Engagement groove of connecting portion
122: Recessed surface portion
126: First binding portion
126D: Lower groove for joining of first binding portion
126F: Front end protrusion of first binding portion
126U: Upper groove for joining of first binding portion
127: Second binding portion
127U: Upper groove for joining of second binding portion
320: Lower support structure
322: Upper support structure

What is claimed is:

1. A horizontal linear vibration generating device, comprising:
a case configured to form a mounting space therein by being coupled with a lower cover;
a vibrating body configured to vibrate in a first direction within the mounting space;
a fixing body including a coil surrounded by the vibrating body and a yoke around which the coil is wound; and
a pair of elastic bodies configured to elastically support vibration of the vibrating body between the case and the vibrating body,
wherein the vibrating body comprises:
a frame portion to which the elastic bodies are connected; and
a plurality of magnets mounted on an inner surface of the frame portion,
wherein the elastic bodies comprise:
a first elastic body configured to elastically support the vibration of the vibrating body from one side; and
a second elastic body configured to elastically support the vibration of the vibrating body from the other side facing the first elastic body, based on the fixing body,
wherein the first elastic body and the second elastic body comprise:
a fixed end welded to the case;
a movable end welded to the frame portion; and
a connecting portion connecting the movable end and the fixed end to each other,
wherein positions on a plane of the fixed end and movable end of the first elastic body is disposed to be diagonally symmetric to positions on a plane of the fixed end and movable end of the second elastic body, and
wherein a line connecting a movable welding point closest to a bridge portion among movable welding points of the movable end, to a fixed welding point closest to the bridge portion among fixed welding points of the fixed end, is positioned within an angle of −5 degrees to +5 degrees with respect to a vertical line drawn in a second direction (y-axis direction) based on the movable welding point of the movable end.

2. The horizontal linear vibration generating device of claim 1, wherein a line connecting the movable welding point closest to the bridge portion of the movable end, to a fixed welding point closest to a connecting portion of the fixed end, coincides with a vertical line drawn in the second direction (y-axis direction) based on the movable welding point of the movable end.

3. The horizontal linear vibration generating device of claim 1, wherein the pair of elastic bodies are plate springs.

4. The horizontal linear vibration generating device of claim 1, wherein the fixing body has a shape symmetrical in a third direction perpendicular to a plane passing through the first direction and the second direction, and
wherein a longitudinal central axis of the yoke coincides with a centerline passing through a center of a height of the vibrating body.

5. The horizontal linear vibration generating device of claim 1, wherein the frame portion comprises a first frame and a second frame, which are coupled in a structure in which portions thereof overlap each other on both sides of the fixing body, and
wherein a portion of the elastic body is inserted and fixed into a gap in a portion where portions of the first frame and the second frame overlap each other.

6. The horizontal linear vibration generating device of claim 5, wherein each of the first frame and the second frame comprises:
a pair of a first binding portion and a second binding portion disposed in parallel in the first direction with the fixing body interposed therebetween; and
a connecting portion connecting ends of the binding portions to each other,
wherein the first binding portion of the first frame and the second binding portion of the second frame overlap each other in parallel in the first direction, and the second binding portion of the first frame and the first binding portion of the second frame overlap each other in parallel in the first direction, and the first frame and the second frame are thus coupled.

7. The horizontal linear vibration generating device of claim 5, wherein
a front end protrusion formed to extend in the first direction from the first binding portion; and
an engagement groove formed in a third direction in the connecting portion, and
wherein the first frame and the second frame are coupled in such a manner that the front end protrusion of the first frame is fitted into the engagement groove of the second frame, and the front end protrusion of the second frame is fitted into the engagement groove of the first frame.

8. The horizontal linear vibration generating device of claim 5, wherein each of the first frame and the second frame comprises:
an upper groove for joining formed in an upper portion of the first binding portion; and
a lower groove for joining formed in a lower portion of the first binding portion,
wherein the first elastic body and the second elastic body are formed to have a height such that upper surfaces and lower surfaces of the first elastic body and the second elastic body are positioned on horizontal planes of the upper groove for joining and the lower groove for joining, such that movable welding points of the first elastic body are spot-welded on horizontal planes of the upper groove for joining and the lower groove for joining of the first binding portion of the first frame, and movable welding points of the second elastic body are spot-welded on horizontal planes of the upper groove for joining and the lower groove for joining of the first binding portion of the second frame.

9. The horizontal linear vibration generating device of claim 5, wherein
first magnets, each mounted on a recessed surface portion formed in the first frame in correspondence to a front surface portion of the fixing body, and a recessed surface portion formed in the second frame in correspondence to a rear surface portion of the fixing body; and
second magnets, each mounted on a surface of a binding frame directly facing one side surface portion of the fixing body among the binding frames of the first frame, and a surface of a binding frame directly facing the other side surface portion of the fixing body among the binding frames of the second frame.
